(19) United States
(12) Patent Application Publication
(10) Pub. No.: US 2006/0095927 A1
(43) Pub. Date: May 4, 2006

(54) Disk device with disk tray removal preventing mechanism

(75) Inventor: Takeshi Makino, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/258,138

(22) Filed: Oct. 26, 2005

(30) Foreign Application Priority Data
Nov. 2, 2004 (JP) 2004-319374

(51) Int. Cl. G11B 17/04; G11B 17/03; G11B 33/02

(52) U.S. Cl. 720/601

(57) ABSTRACT

The present invention provides a disk device with an easy-removal disk tray removal preventing mechanism. A disk tray is housed in a main body frame. First and second stoppers and 6 are formed in the disk tray. A first rib 12 is formed in the main body frame. A second rib is provided at a rack loading placed in the main flame. Operation portions are provided on the first and second stoppers; the operation portions are bent toward the inside of the disk tray to disengage the first rib from the first engaging portion of the first stopper, while disengaging the second rib from the second engaging portion of the second stopper. By bending the operation portions toward the inside of the disk tray, it is possible to disengage the first and second engaging portions from the first and second ribs respectively, and the disk tray is easily removed.

The present application is based on and claims priority of Japanese patent application No. 2004-319374 filed on Nov. 2, 2004, the entire contents of which are hereby incorporated by reference.

### BACKGROUND OF THE INVENTION

1. Field of the Invention

The present invention relates to a disk device that records and reproduces data on and from a disk serving as a recording medium, and more specifically, to a disk device with a disk tray removal preventing mechanism that prevents a disk tray on which a disk is placed from being easily removed even when the disk tray is subjected to an external pressure, for example, a pulling force.

2. Description of the Related Art

For disk devices that record or reproduce data on or from a disk such as a CD-R, a structure has hitherto been proposed in which the disk is placed on a tray conveyed into and out of an apparatus main body so that it can be loaded into the apparatus main body. As such a conventional technique, Japanese Patent Laid-Open Publication No. 2003-281868 (Patent Document 1) discloses a disk driving device configured to prevent a tray on which a disk is placed from being separated from a main body frame such as an apparatus main body when an unexpected force is exerted on the tray.

With the patent document 1, when the tray is unloaded from the main body frame serving as the apparatus main body and then a user exerts an inadvertent external force on the tray by, for example, pulling it from the main body frame, the tray is prevented from being separated from the main body frame. However, when the tray must be removed from the main body frame for maintenance or the like, the maintenance operation cannot be easily performed because the device is configured to prevent the tray from being readily separated.

### SUMMARY OF THE INVENTION

The present invention is made in view of the above problems. It is an object of the present invention to provide a disk device with a disk tray removal preventing mechanism which can prevent a disk tray from being easily removed even when a user or the like exerts an inadvertent external force on the disk tray and which enables the disk tray to be easily removed from a main body when the disk tray must be removed for maintenance or the like.

According to a first aspect of the present invention, there is provided a disk device with a disk tray removal preventing mechanism, the disk device comprising a disk tray that conveys a disk inward and outward which is placed on the disk tray, a main body frame in which the disk tray is housed, a rack loading slidably placed on the main body frame, and a traverse unit raised and lowered in unison with a sliding operation of the rack loading, the disk tray removal preventing mechanism comprising a first stopper formed at one of rear ends of the disk tray, a first rib formed in a front of the main frame and which engages with the first stopper, a second stopper formed at a rear end of the disk tray which is located opposite the first stopper, and a second rib formed at a top of the rack loading and which engages with the second stopper when the traverse unit is lowered.

According to a second aspect of the present invention, there is provided a disk device with a disk tray removal preventing mechanism, the disk device comprising a disk tray that conveys a disk inward and outward which is placed on the disk tray, a main body frame in which the disk tray is housed, a rack loading slidably placed on the main body frame, and a traverse unit raised and lowered in unison with a sliding operation of the rack loading, the disk tray removal preventing mechanism comprising stoppers formed at both rear ends of the disk tray and ribs formed in a front of the main frame and which engage with the respective stoppers, the ribs being extended from upper ends of both side walls of the main body frame toward the inside.

According to a third aspect of the present invention, in the disk device with a disk tray removal preventing mechanism according to the second aspect, a guide rib is formed integrally with each of the ribs to guide the disk tray when the disk tray conveys the disk.

According to a fourth aspect of the present invention, in the disk device with a disk tray removal preventing mechanism according to the second or third aspect, one end of the stopper is integrally connected to the disk tray, and an engaging portion is integrally formed at the other end of the stopper and engages with the rib formed on the main body frame and/or the rack loading.

According to a fifth aspect of the present invention, in the disk device with a disk tray removal preventing mechanism according to any of the second to fourth aspects, an operation portion is integrally formed at a top of the stopper and is bent toward an inside of the disk tray to disengage the rib from the stopper.

According to a sixth aspect of the present invention, in the disk device with a disk tray removal preventing mechanism according to the first aspect, operation portions are integrally formed at a top of the first and second stoppers and are bent toward an inside of the disk tray to disengage the first and second ribs from the first and second stoppers, respectively.

### BRIEF DESCRIPTION OF THE DRAWINGS

FIG. 1 is a plan view of a disk device contained in an electronic apparatus in accordance with Embodiment 1 of the present invention;

FIG. 2 is a front view of the disk device;

FIG. 3 is a plan view of a main body frame showing that a disk tray has been removed from the disk device;

FIG. 4 is a front view of the main frame showing that a disk tray has been removed from the disk device;

FIG. 5 is a plan view of a rack loading in the disk device;

FIG. 6 is a front view of the rack loading in the disk device;

FIG. 7 is an enlarged perspective view showing the vicinity of a stopper in the disk device;

FIG. 8 is a partly cutaway enlarged perspective view of the stopper in the disk device;

FIG. 9 is a plan view of a disk device in accordance with Embodiment 2 of the present invention;

FIG. 10 is a front view of the disk device in accordance with Embodiment 2;

FIG. 11 is an enlarged perspective view showing the vicinity of a stopper in the disk device;

FIG. 12 is an enlarged perspective view showing the vicinity of an engaging rib in the disk device;

FIG. 13 is an enlarged perspective view showing a guide rib in the disk device;

FIG. 14 is an enlarged perspective view of the disk tray showing the vicinity of the stopper in the disk device;

FIG. 15 is a plan view of a disk device in accordance with Embodiment 3 of the present invention;

FIG. 16 is a front view of the disk device in accordance with Embodiment 3;

FIG. 17 is an enlarged perspective view showing a stopper and a rib in the disk device; and

FIG. 18 is an enlarged perspective view of an engaging portion shown by a dashed line and which engages with the rib.

### DETAILED DESCRIPTION OF THE PREFERRED EMBODIMENTS

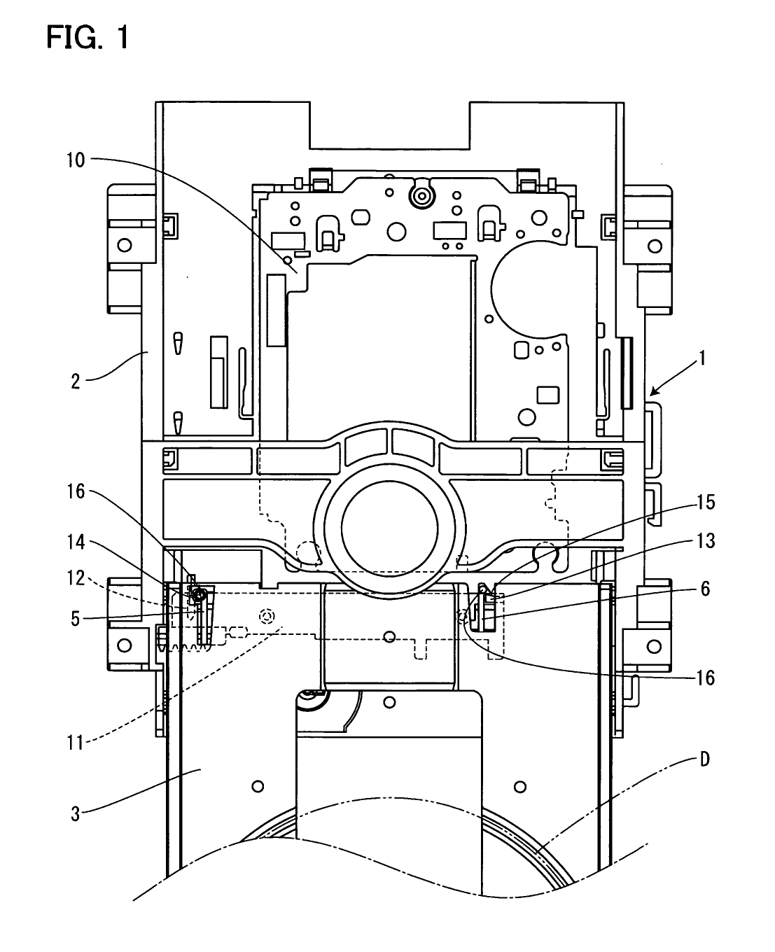

With reference to FIGS. 1 to 18, description will be given below of embodiments of the present invention as the best mode for carrying out the present invention.

### Embodiment 1

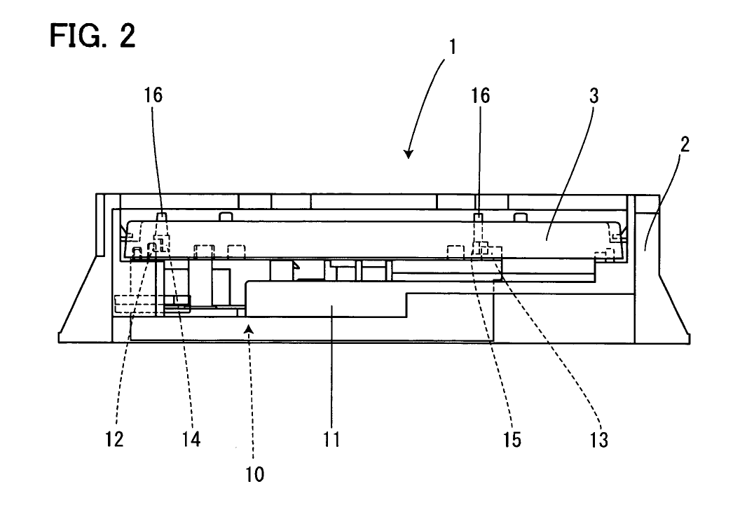

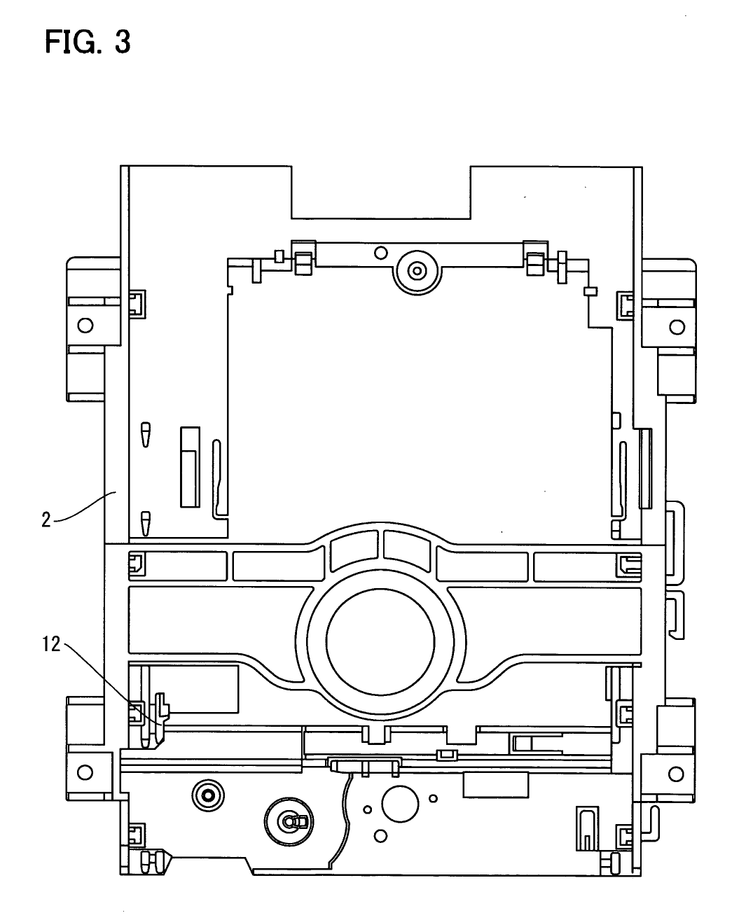

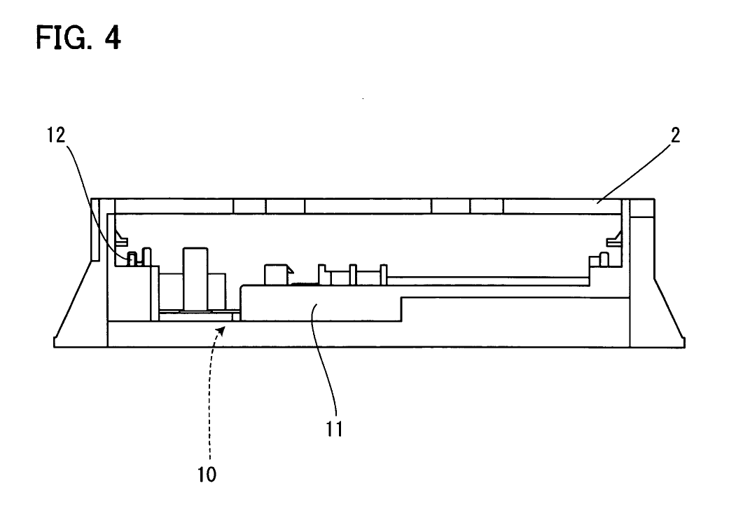

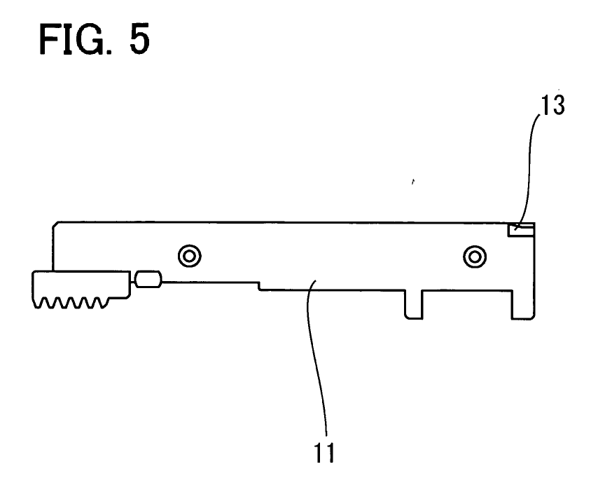

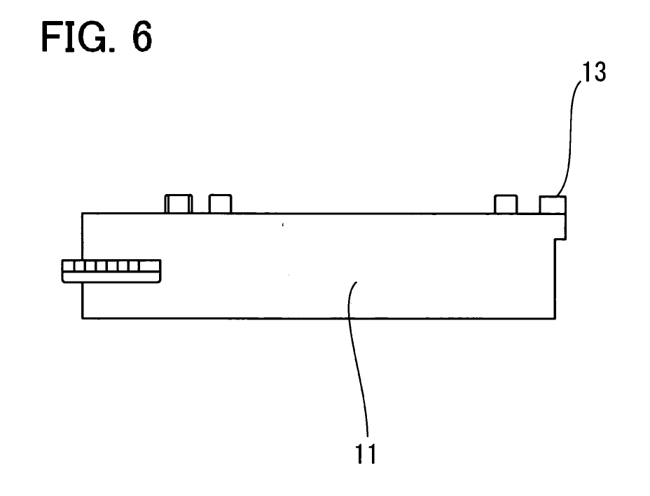

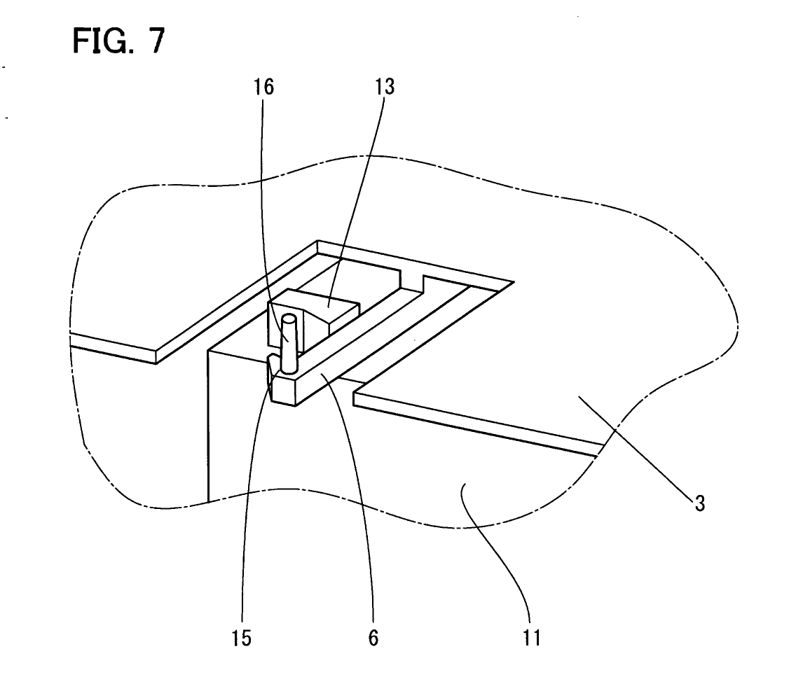

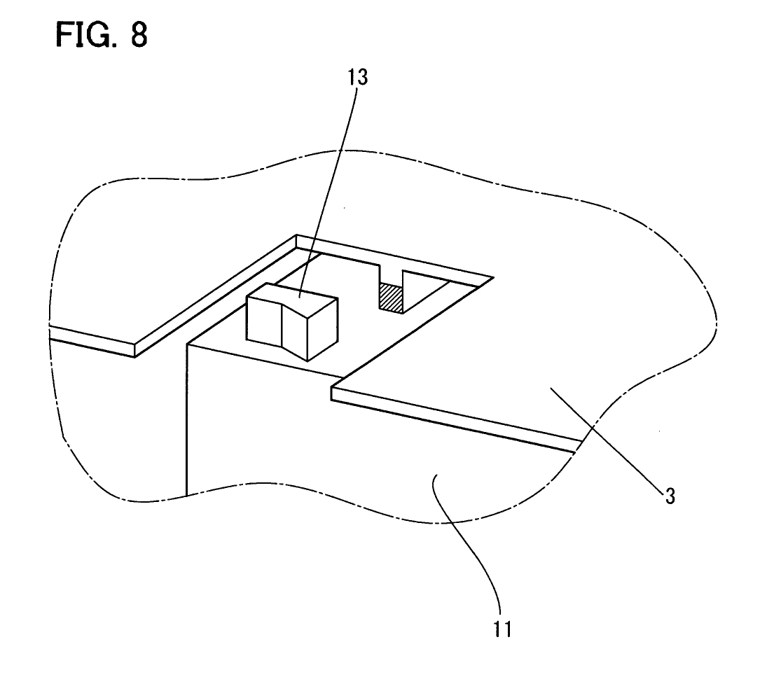

FIG. 1 is a plan view of a disk device contained in an electronic apparatus in accordance with an embodiment of the present invention. FIG. 2 is a front view of the disk device. FIG. 3 is a plan view of a main body frame showing that a disk tray has been removed from the disk device. FIG. 4 is a front view of the main frame. FIG. 5 is a plan view of a rack loading. FIG. 6 is a front view of the rack loading. FIG. 7 is an enlarged perspective view showing the vicinity of a stopper. FIG. 8 is a partly cutaway enlarged perspective view of the stopper. As shown in these figures, a disk device 1 has a main body frame 2 comprising a disk tray 3 on which a disk D that is a recording medium such as a CD-R is placed. A driving mechanism constituting a driving motor (not shown) is provided in the main frame 2 to move the disk tray 3 forward and backward in the main body frame 2. When the disk tray 3 is moved forward in the main body frame 2, that is, the disk tray 3 is unloaded from the main body frame 2 and then stopped, the disk D can be placed at a predetermined position on the disk tray 3.

The disk tray 3 is generally shaped like a rectangle as viewed from above. The disk tray 3 has a first stopper 5 formed at one (left end in FIG. 1) of the rear ends. The disk tray 3 also has a second stopper 6 formed at its rear end (right end in FIG. 1) located opposite the first stopper 5; the second stopper 6 is integrated with the disk tray 3.

Reference numeral 10 denotes a traverse unit mounted on the main body frame 2 and comprising a turntable, a pickup unit, and the like as main components; the turntable is used to rotate the disk D loaded into the disk device 1, and the pickup unit read or write information from or to the rotating disk D. A rack loading 11 shown in FIGS. 5 and 6 is placed in front of the traverse unit 10. A cam groove (not shown) is formed in the rack loading 11. A projection (not shown) is provided at a leading end of the traverse unit 10 and is fitted into the cam groove. As the rack loading 11 slides, the traverse unit 10 rises or lowers.

A first rib 12 is integrally formed in the front of the main body frame 2. A second rib 13 is integrally formed on the rack loading 11.

An externally bent first engaging portion 14 is formed at a leading end of the first stopper 5. An externally bent second engaging portion 15 is also formed at a leading end of the second stopper 6. Thus, when the disk tray 3 is conveyed to a disk change position where the disk D can be placed, the first rib 12 engages with the first engaging portion 14, while the second rib 13 engages with the second engaging portion 15. Operation portions 16, 16 are integrally formed at the top of the first stopper 5 and second stopper 6 so as to project upward from the stoppers. When the operation portions 16, 16 are bent toward the inside of the disk device 1, the first engaging portion 14 engaged with the first rib 12 and the second engaging portion 15 engaged with the second rib 13 are moved inward in accordance with the bending of the operation portions 16, 16. This disengages the first and second engaging portions 14 and 15 from the first and second ribs 12 and 13, respectively. Thus, when the disk tray 3 must be removed from the main body frame 2 for maintenance or the like, the disk tray 3 can be easily separated and removed from the main body frame 2 by bending the operation portions 16, 16 toward the inside so that they are sandwiched between the thumb and forefinger of one hand, even with the other hand open. Further, as shown in FIG. 1, when the disk tray 3 is at a position where the disk D can be changed, even if an inadvertent external force is exerted on the disk tray 3, the disk tray 3 can be prevented from being easily removed from the main body frame 2 of the disk device 1 owing to the engagement between the first engaging portion 14 and the first rib 12 and between the second engaging portion 15 and the second rib 13.

As described above, the disk device 1 is provided with the disk tray 3 that conveys the disk D inward and outward which is placed on the tray, the main body frame 2 in which the disk tray 3 is housed, the first stopper 5 formed at one of the rear ends of the disk tray 3, the first rib 12 formed in the front of the main body frame 2, the second stopper 6 formed at the rear end of the disk tray 3 which is located opposite the first stopper 5, and the second rib 13 formed on the rack loading 11 that raises and lowers the traverse unit 10 provided in the main body frame 2. The externally bent first engaging portion 14 is formed at the leading end of the first stopper 5. The externally bent second engaging portion 15 is formed at the leading end of the second stopper 6. When the disk tray 3 moves forward and is thus unloaded from the main body frame 2, the first engaging portion 14 engages with the first rib 12, while the second engaging portion 15 engages with the second rib 13. The operation portions 16, 16 are integrally provided at the top of the first and second stoppers 5 and 6; when the disk tray 3 is unloaded and placed at the position where the disk D is changed, the operation portions 16, 16 are bent to the inside of the disk device 1 to disengage the first and second ribs 12 and 13 from the first and second engaging portions 14 and 15, respectively. Thus, even if an inadvertent external force is exerted on the disk tray 3 when it is at the position where the disk D is changed, the disk tray 3 can be prevented from being removed from the main body frame 2 of the disk device 1 because the first engaging portion 14 is engaged with the first rib 12 with the second engaging portion 15 engaged with the second rib 13. Moreover, by bending the operation portions 16, 16 toward the inside of the main body frame 2, it is possible to disengage the first and second engaging portions 14 and 15 from the first and second ribs 12 and 13, respectively. Consequently, when the disk tray 3 must be removed from the main body frame 2 for maintenance or the like, the disk tray 3 can be easily separated and removed from the main body frame by bending the operation portions 16, 16 toward the inside so that they are sandwiched between the thumb and forefinger of one hand, even with the other hand open.

Further, as shown in FIG. 2, the second rib 13 engaged with the second engaging portion 15 of the second stopper 6 is formed on the rack loading 11. It is thus possible to omit a rib conventionally formed on the frame of the disk device. This makes it possible to simplify the shape of the main body frame 2. A space can be provided around the omissible second rib 13 so that various parts can be installed in the space as required.

### Embodiment 2

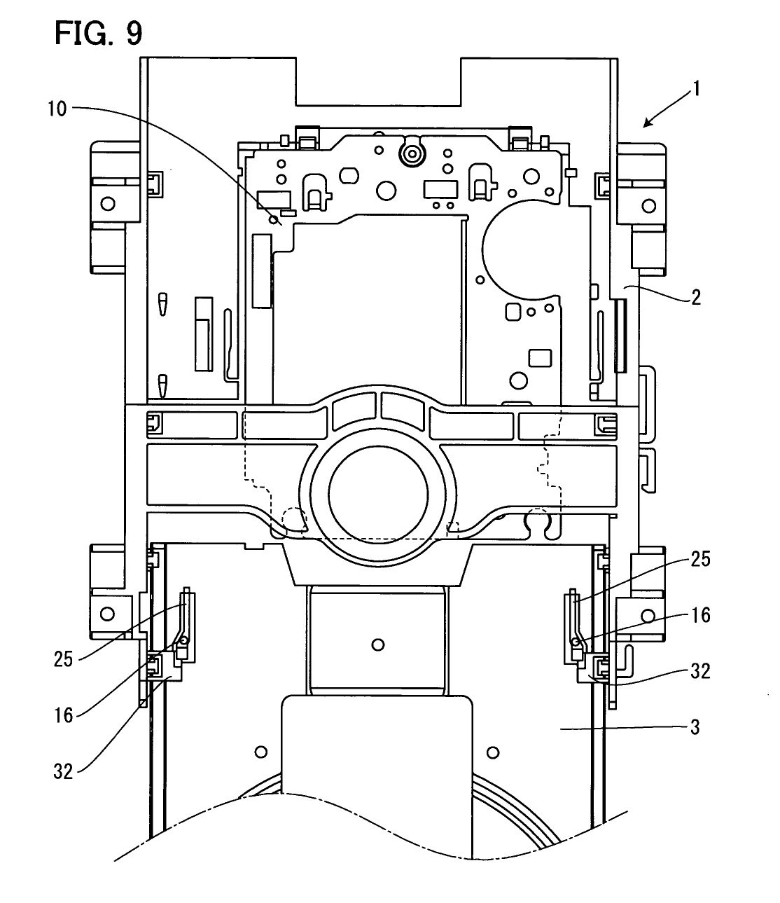

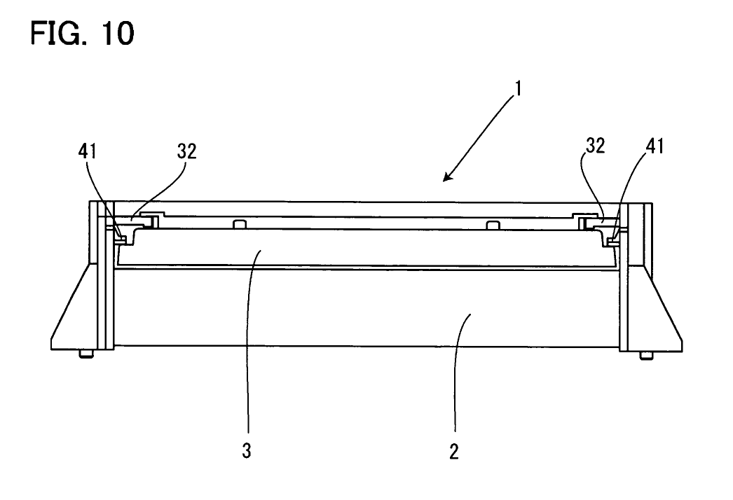

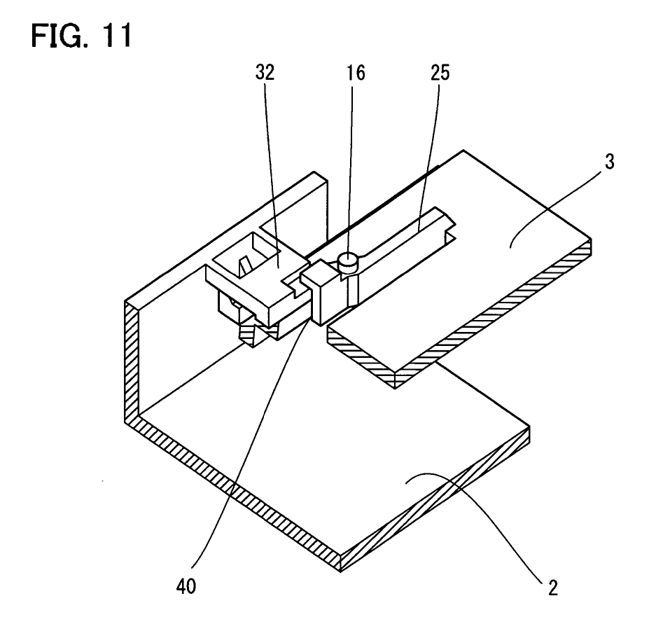

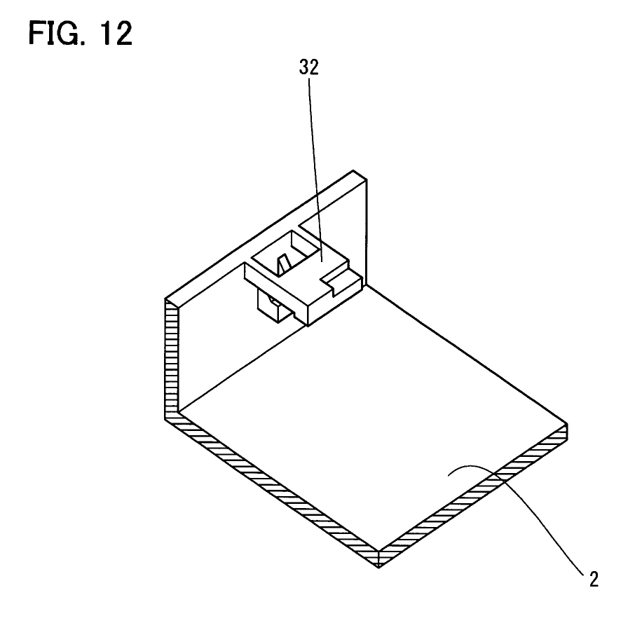

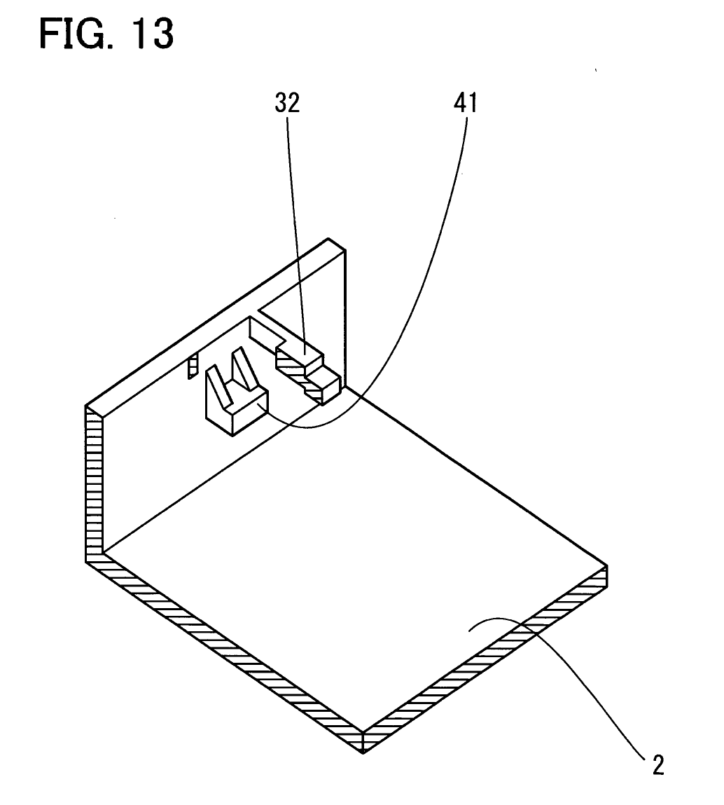

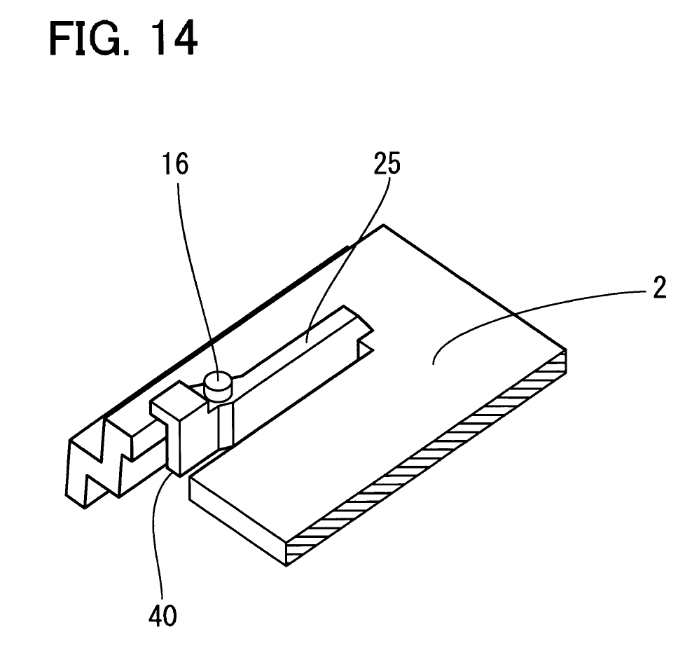

Now, Embodiment 2 of the present invention will be described. FIG. 9 is a plan view of a disk device shown in Embodiment 2 of the present invention. FIG. 10 is a front view of the disk device. FIG. 11 is an enlarged perspective view showing the vicinity of a stopper. FIG. 12 is an enlarged perspective view showing the vicinity of an engaging rib. FIG. 13 is an enlarged perspective view showing a guide rib on a disk tray. FIG. 14 is an enlarged perspective view of the disk tray showing the vicinity of the stopper. The same parts as those in Embodiment 1, described above, have the same reference numerals. Their detailed description will be omitted.

In Embodiment 2, as shown in FIG. 9, stoppers 25, 25 are integrally formed at the respective rear ends of the disk tray. Engaging portions 40, 40 are formed at leading ends of the respective stoppers 25, 25 as shown in FIG. 11. Operation portions 16, 16 are integrally formed at the top of the stoppers 25, 25.

Engaging ribs 32, 32 are formed at upper ends of front parts of the respective sides of the main body frame 2 so as to extend toward the inside of the disk tray. Even if an inadvertent external force is exerted on the disk tray 3 when it is located at the position where the disk D is changed, the disk tray 3 can be prevented from being removed from the main body frame 2 of the disk device 1. This is because the engaging portions 40, 40 are engaged with the engaging ribs 32, 32. In addition, as shown in FIG. 13, guide ribs 41, 41 are formed below the engaging ribs 32, 32 close to or integrally with them to guide the main body frame 2 when the disk tray 3 conveys the disk. When the guide ribs 41, 41 are provided close to or integrally with the engaging ribs 32, 32, it is possible to simplify the shape of a mold used to mold the main body frame 2 by setting a cavity mold and a core mold across the height of the main body frame 2. Furthermore, when the guide ribs 41, 41 are provided close to or integrally with the engaging ribs 32, 32, the disk tray 3 can be prevented from being inadvertently tilted or vibrated when it is conveyed to the position where the disk D is changed. Moreover, when the engaging ribs 32, 32 that engage with the engaging portions 40, 40 of the stoppers 25, 25 are formed at the upper end of the main body frame 2, the removal preventing mechanism for the disk tray 3 can be provided regardless of a reduction in the thickness of the disk device. That is, if the height of the whole main body frame 2 is reduced, the stoppers 25, 25 can be formed on the top surface of the disk tray 3. The corresponding engaging rib 32, 32 can be formed at the upper end of the main body frame 2 in accordance with the height of the engaging portions 40, 40 of the stoppers 25, 25. Further, when the engaging ribs 32, 32 that engage with the engaging portions 40, 40 of the stoppers 25, 25 are formed at the upper end of the main body frame 2, a space can be provided inside the main body frame 2 so that various parts can be installed in the space as required.

### Embodiment 3

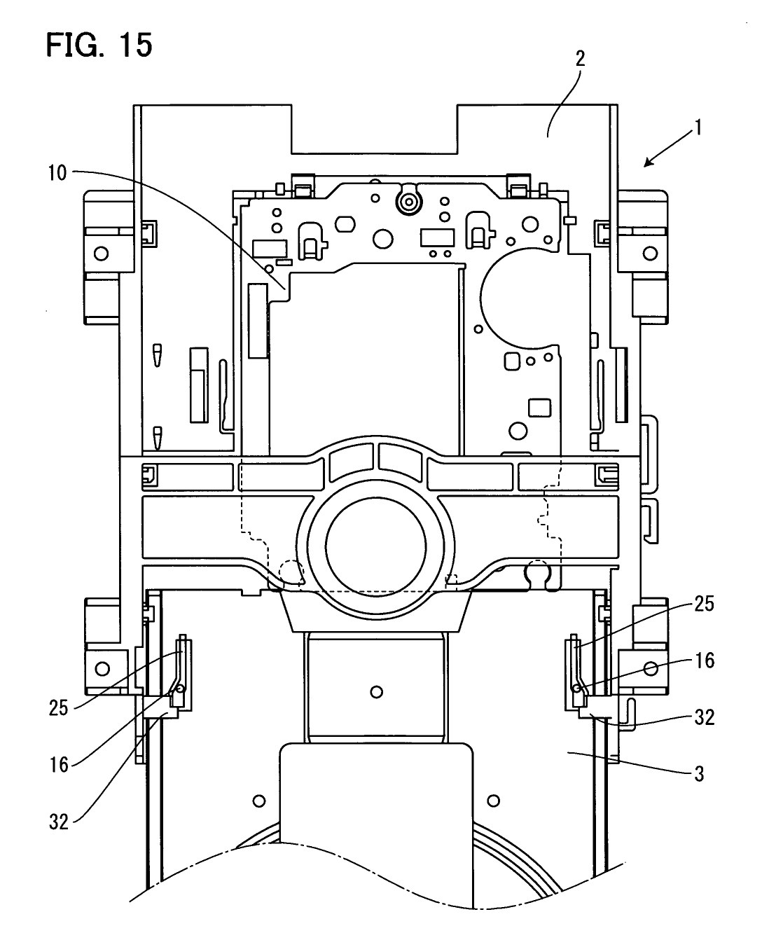

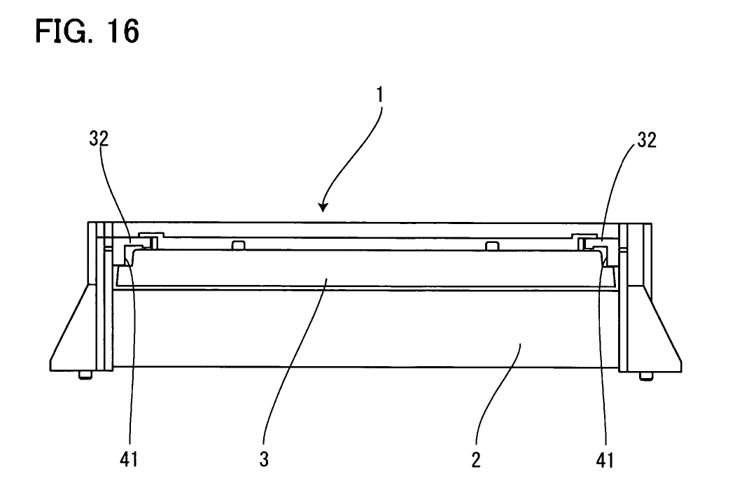

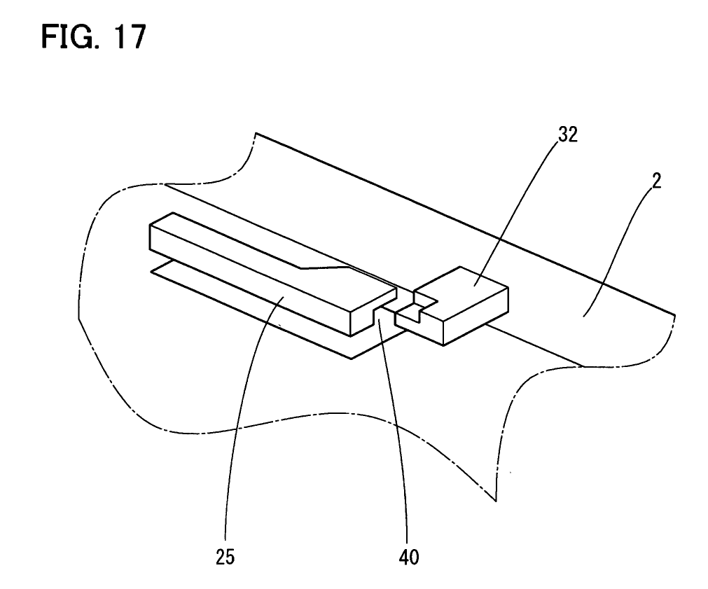

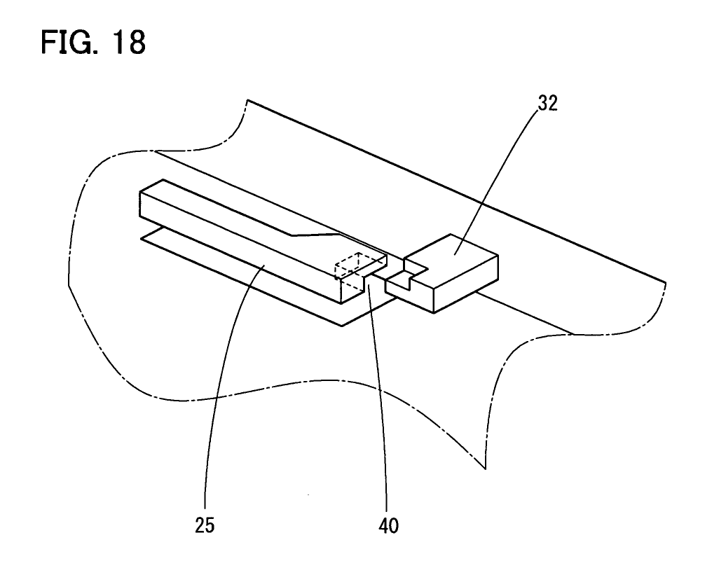

Now, Embodiment 3 of the present invention will be described. FIG. 15 is a plan view of a disk device shown in Embodiment 3 of the present invention. FIG. 16 is a front view of the disk device. FIG. 17 is an enlarged perspective view showing a stopper and a rib. FIG. 18 is an enlarged perspective view of an engaging portion shown by a dashed line and which engages with the rib. The same parts as those in Embodiments 1 and 2, described above, have the same reference numerals. Their detailed description will be omitted.

In Embodiment 3, the stoppers 25, 25 are formed on the top surface of the disk tray 3. The operation portions 16, 16 are formed at the leading ends of the stoppers 25, 25 extended forward from the respective rear ends of the disk tray 3. The engaging portions 40, 40 of the stoppers 25, 25 engage with the engaging ribs 32, 32 formed on the main body frame 2. The guide ribs 41, 41 are formed in the front parts of respective sides of the main body frame 2 so as to extend toward the inside of the disk tray; the guide ribs 41, 41 are also used as guides when the disk tray 3 conveys the disk. Thus, as in the case of Embodiment 2, the engaging ribs 32, 32 are formed at the upper ends of front parts of the respective sides of the main body frame 2 so as to extend toward the inside of the disk tray. Even if an inadvertent external force is exerted on the disk tray 3 when it is located at the position where the disk D is changed, the disk tray 3 can be prevented from being removed from the main body frame 2 of the disk device 1. This is because the engaging portions 40, 40 are engaged with the engaging ribs 32, 32. In addition, the guide ribs 41, 41 are formed below the engaging ribs 32, 32 close to or integrally with them to guide the main body frame 2 when the disk tray 3 conveys the disk. When the guide ribs 41, 41 are provided close to or integrally with the engaging ribs 32, 32, it is possible to simplify the shape of a mold used to mold the main body frame 2 by setting a cavity mold and a core mold across the height of the main body frame 2. Furthermore, when the guide ribs 41, 41 are provided close to or integrally with the engaging ribs 32, 32, the disk tray 3 can be prevented from being inadvertently tilted or vibrated when it is conveyed to the position where the disk D is changed. Moreover, when the engaging ribs 32, 32 that engage with the engaging portions 40, 40 of the stoppers 25, 25 are formed at the upper end of the main body frame 2, the removal preventing mechanism for the disk tray 3 can be provided regardless of a reduction in the thickness of the disk device. That is, if the height of the whole main body frame 2 is reduced, the stoppers 25, 25 can be formed on the top surface of the disk tray 3. The corresponding engaging rib 32, 32 can be formed at the upper end of the main body frame 2 in accordance with the height of the engaging portions 40, 40 of the stoppers 25, 25. Further, when the engaging ribs 32, 32 that engage with the engaging portions 40, 40 of the stoppers 25, 25 are formed at the upper end of the main body frame 2, a space can be provided inside the main body frame 2 so that various parts can be installed in the space as required.

The effect of the present invention is as follows.

According to the present invention, even if an inadvertent external force is exerted on the disk tray when it is located at a disk change position, the disk tray can be prevented from being removed from the main body frame of the disk device. This is because the first engaging portion is engaged with the first rib, while the second engaging portion is engaged with the second rib. Further, by bending the operation portions toward the inside of the main body frame, it is possible to disengage the first and second engaging portions from the first and second ribs, respectively. Consequently, for example, when the disk tray must be removed from the main body frame for maintenance or the like, the disk tray can be easily separated and removed from the main body frame by bending the operation portions toward the inside so that they are sandwiched between the thumb and forefinger of one hand, even with the other hand open.

Further, even when an inadvertent external force is exerted on the disk tray located at the disk change position, the disk tray can be prevented from being removed from the main body frame of the disk device because the engaging portion is engaged with the rib. When the guide rib is provided close to or integrally with the rib, it is possible to simplify the shape of a mold used to mold the main body frame by setting a cavity mold and a core mold across the height of the main body frame. Furthermore, when the guide rib are provided close to or integrally with the rib, the disk tray can be prevented from being inadvertently tilted or vibrated when it is conveyed to the disk change position. Moreover, when the engaging rib that engages with the engaging portion of the stopper is formed at the upper end of the main body frame, the disk tray removal preventing mechanism can be provided regardless of a reduction in the thickness of the disk device. Accordingly, if the height of the whole main body frame is reduced, the stopper can be formed on the top surface of the disk tray. The corresponding rib can be formed at the upper end of the main body frame in accordance with the height of the engaging portion of the stopper. Further, when the rib that engages with the engaging portion of the stopper is formed at the upper end of the main body frame, a space can be provided inside the main body frame so that various parts can be installed in the space as required.

1. A disk device with a disk tray removal preventing mechanism, the disk device comprising a disk tray that conveys a disk inward and outward which is placed on the disk tray, a main body frame in which the disk tray is housed, a rack loading slidably placed on the main body frame, and a traverse unit raised and lowered in unison with a sliding operation of the rack loading, the disk tray removal preventing mechanism comprising a first stopper formed at one of rear ends of the disk tray, a first rib formed in a front of the main frame and which engages with the first stopper, a second stopper formed at a rear end of the disk tray which is located opposite the first stopper, and a second rib formed at a top of the rack loading and which engages with the second stopper when the traverse unit is lowered.

2. A disk device with a disk tray removal preventing mechanism, the disk device comprising a disk tray that conveys a disk inward and outward which is placed on the disk tray, a main body frame in which the disk tray is housed, a rack loading slidably placed on the main body frame, and a traverse unit raised and lowered in unison with a sliding operation of the rack loading, the disk tray removal preventing mechanism comprising stoppers formed at both rear ends of the disk tray and ribs formed in a front of the main frame and which engage with the respective stoppers, the ribs being extended from upper ends of both side walls of the main body frame to the inside.

3. The disk device with a disk tray removal preventing mechanism according to claim 2, wherein a guide rib is formed integrally with each of the ribs to guide the disk tray when the disk tray conveys the disk.

4. The disk device with a disk tray removal preventing mechanism according to claim 2, wherein one end of the stopper is integrally connected to the disk tray, and an engaging portion is integrally formed at the other end of the stopper and engages with the rib formed on the main body frame and/or the rack loading.

5. The disk device with a disk tray removal preventing mechanism according to claim 2, wherein an operation portion is integrally formed at a top of the stopper and is bent toward an inside of the disk tray to disengage the rib from the stopper.

6. The disk device with a disk tray removal preventing mechanism according to claim 1, wherein operation portions are integrally formed at a top of the first and second stoppers and are bent toward an inside of the disk tray to disengage the first and second ribs from the first and second stoppers, respectively.

7. The disk device with a disk tray removal preventing mechanism according to claim 3, wherein one end of the stopper is integrally connected to the disk tray, and an engaging portion is integrally formed at the other end of the stopper and engages with the rib formed on the main body frame and/or the rack loading.

8. The disk device with a disk tray removal preventing mechanism according to claim 3, wherein an operation portion is integrally formed at a top of the stopper and is bent toward an inside of the disk tray to disengage the rib from the stopper.

9. The disk device with a disk tray removal preventing mechanism according to claim 4, wherein an operation portion is integrally formed at a top of the stopper and is bent toward an inside of the disk tray to disengage the rib from the stopper.

10. The disk device with a disk tray removal preventing mechanism according to claim 7, wherein an operation portion is integrally formed at a top of the stopper and is bent toward an inside of the disk tray to disengage the rib from the stopper.
